(19) United States
(12) Patent Application Publication
(10) Pub. No.: US 2012/0079696 A1
(43) Pub. Date: Apr. 5, 2012

(54) PLASTIC BAG WASHING SUPPORT FOR DISHWASHER

(75) Inventors: Valerie Fern Hoy, Tualatin, OR (US); Howard Russell Hoy, Tualatin, OR (US)

(73) Assignee: RHODEHAMEL LLC, Tualatin, OR (US)

(21) Appl. No.: 13/250,569

(22) Filed: Sep. 30, 2011

Related U.S. Application Data
(60) Provisional application No. 61/404,241, filed on Sep. 30, 2010.

(51) Int. Cl. A47L 15/42; B23P 11/00

(52) U.S. Cl. 29/426.2; 248/95; 29/428

(57) ABSTRACT

Embodiments herein relate to the field of reusable storage bags, and, more specifically, to support systems for holding plastic bags of various dimensions open to facilitate washing in a dishwasher for later re-use. In various embodiments, the device may include first and second bag support members having a center shaft with a first end adapted to engage a prong of a dishwasher rack, and a second end adapted to retain a plastic bag in a desired position. In use, the first and second bag support members are placed over prongs having a desired spacing, and the bag is placed over the two support devices, where it is retained during the wash cycle of the dishwasher. The shape of the bag support members is adapted to retain the bag in an open position throughout the wash cycle, without allowing the plastic bag to tent or cause pooling.

### CROSS REFERENCE TO RELATED APPLICATION

The present application claims priority to U.S. Provisional Patent Application No. 61/404,241, filed Sep. 30, 2010, entitled “PLASTIC BAG WASHING SUPPLEMENT FOR DISHWASHER,” the disclosure of which is hereby incorporated by reference in its entirety.

### TECHNICAL FIELD

Embodiments herein relate to the field of reusable storage bags, and, more specifically, to support systems for holding plastic bags of various sizes and shapes open to facilitate washing in a dishwasher for later re-use.

### BACKGROUND

Consumers clean various sizes and types of plastic bags for reuse in the interest of frugality, as well as out of concern for the environment. For example, many budget conscious parents wash and reuse the single-portion bags they use in their children's lunch boxes, rather than throwing them away after a single use. However, when such bags are hand washed, products that are oily, such as peanut butter or cheese, may leave behind a residue that is difficult to eradicate. Similarly, food residues that are left behind when bags are reused may harbor bacteria and other illness-causing agents. In particular, even when hand washed using hot water and liquid dish detergent, it may be difficult to determine whether the entire bag surface is clean, especially the corners and the closing mechanism. Furthermore, such bags are flexible and wrinkle easily, which makes it very difficult to hold them flat to wash by hand with a washrag or other washing utensil.

Another food storage product is a vacuum-sealed plastic bag. Such bags typically make use of a small pump that removes the air from the bag to keep the contents fresh, and such bags are typically more expensive than the traditional sandwich or snack sized plastic bag. Similar vacuum-sealed bags include rolls of bags that may be heat-sealed at one or both ends. Even these heat-sealable bags may be cut open, washed, and reused.

Produce bags also may be washed and reused, and such bags often come in larger sizes to accommodate oversized fruits and vegetables. Over a billion of these single-use plastic bags are given out each day. These and other single-use bags pose health threats to marine and terrestrial life, and may take up to 1,000 years to degrade in landfills. Additionally, trash hauling and disposal of plastic bag waste creates an additional environmental impact. It is estimated that 8 billion pounds of plastic bags, wraps, and sacks enter the waste stream every year in the U.S. alone, putting an unnecessary burden on our diminishing landfill space and causing air pollution if incinerated.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1 illustrates a perspective view of an example of a bag support device, in accordance with various embodiments;

FIGS. 2A and 2B illustrate a side view (FIG. 2A) and a front view (FIG. 2B) of an example of a bag support device, in accordance with various embodiments; and

FIG. 3 illustrates a bottom view of an example of a bag support device, in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “NB” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

Embodiments herein provide bag support devices that permit the effective and efficient washing of plastic bags of various types and sizes in a dishwasher. In various embodiments, the support device typically is used in pairs, and includes a center shaft portion having a proximal end and a distal end. In various embodiments, the proximal end may be adapted to fit securely over a prong of a standard dishwasher rack, whereas the distal end may include a flattened, paddle-shaped portion adapted to support a bag in an open position. In specific, non-limiting embodiments, the proximal end may be adapted to prevent rotation of the device on the dishwasher prong during use, and/or may be adapted to fit both straight prongs and curved, angled, or bent prongs or tines of a dishwasher rack.

In use, two or more bag supports may be positioned over corresponding prongs or tines of a dishwasher rack such that they are an appropriate distance from one another to retain a selected bag in an open position when the bag is placed upside-down and/or inside out over the supports. The dishwasher may then be operated in the normal fashion in order to wash the bag thoroughly on both the inside and outside surfaces, including corners and closure devices, with minimal surface area contact between the bag and the support device. In various embodiments, the bag support devices may then be retained in the dishwasher for further use, removed from the dishwasher for storage, or moved to a different position within the dishwasher, for example to accommodate a second bag having dimensions that differ from the first bag.

In various embodiments, the bag support device may be easily used by individuals having limited dexterity or hand mobility (e.g., it may be used by people of all ages, including children and people with arthritis) because it includes no clips or other fastening members that must be employed to secure or remove the bag. Additionally, in various embodiments, the device may be left in the dishwasher indefinitely without impeding the loading, washing, or unloading of other dishes, eliminating the need for adjustments and reducing the number of steps required to wash a bag. In embodiments, the support device may be coupled to (e.g., slipped over) a single dishwasher prong or tine, and maybe coupled and uncoupled with a single hand. Furthermore, in various embodiments, the device may be adapted to wash any size bag simply by moving the two opposing members to prongs or tines in the dishwasher rack having the desired spacing between them.

In various embodiments, the bag support device may be made from any non-corroding material that is sufficiently strong to withstand the turbulence of a dishwasher cycle, while providing sufficient support to a bag during the washing process. Specific, non-limiting examples of suitable materials include plastic, rubber and other polymers, resins, silicone, and elastomers having sufficient rigidity to provide adequate support to the bag, and non-corroding metals such as aluminum and stainless steel. In addition, in various embodiments, the bag support device may include renewable and/or recyclable materials, such as wood chips or pulp, other natural fibers, seeds and/or oils such as flax and linseed, and/or post-consumer materials, such as recycled plastics.

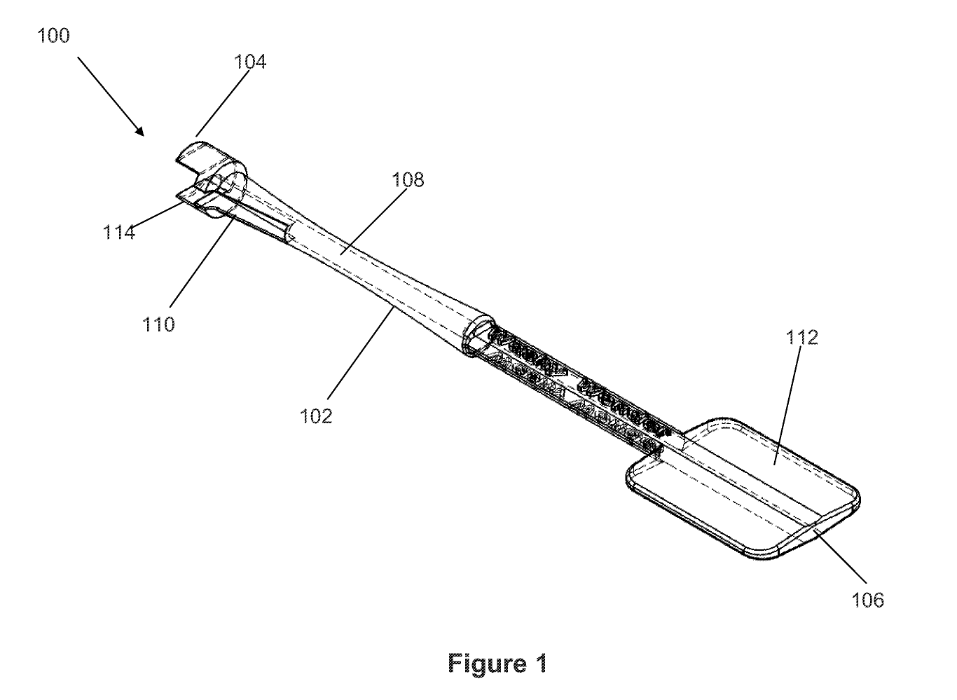

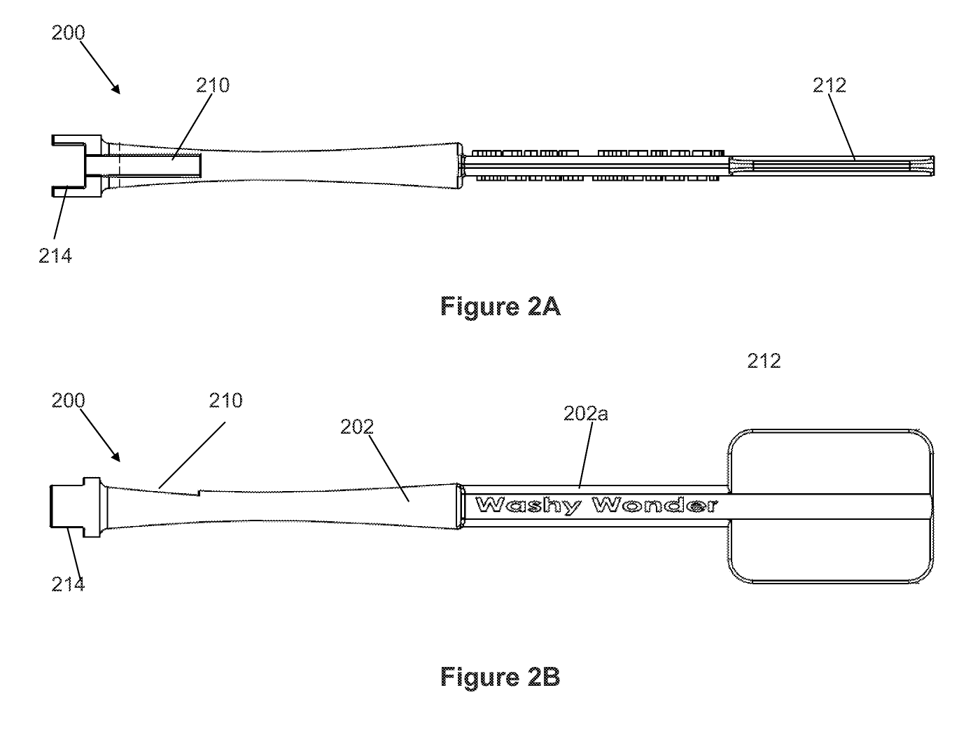

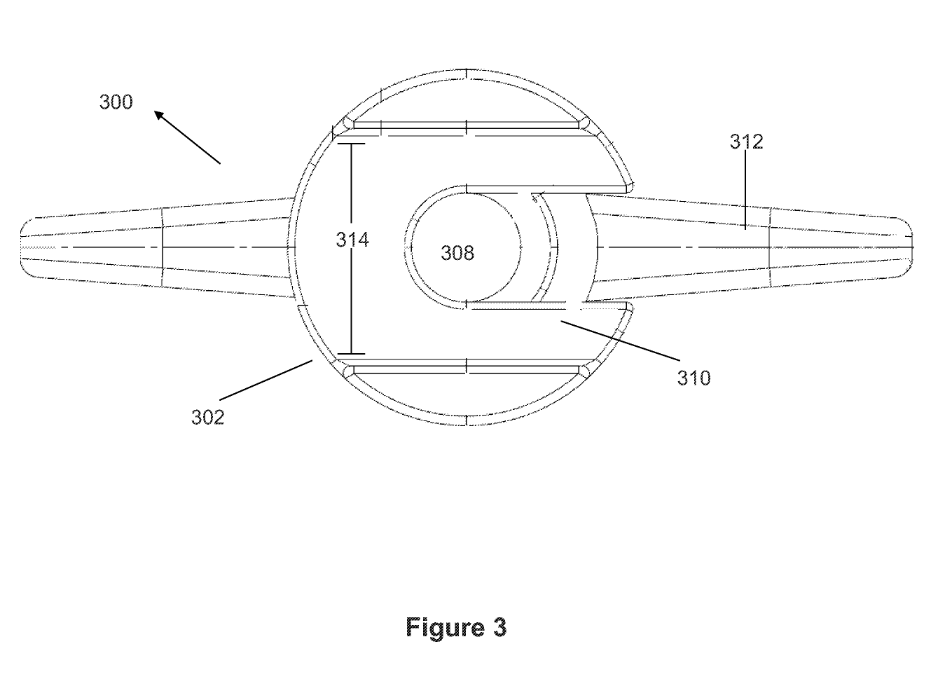

FIG. 1 illustrates a perspective view of an example of a bag support device, in accordance with various embodiments; FIGS. 2A and 2B illustrate a side view (FIG. 2A) and a front view (FIG. 2B) of an example of a bag support device, in accordance with various embodiments; and FIG. 3 illustrates a bottom view of an example of a bag support device, in accordance with various embodiments. As illustrated in FIG. 1, in various embodiments, the bag support device 100 may include a center shaft portion 102 having a proximal end 104 and a distal end 106. In various embodiments, proximal end 104 may include a recess or concavity 108 that may be sized and shaped to fit securely over a standard dishwasher rack prong or tine. In various embodiments, the length of concavity 108 may be sufficient to partially or completely cover a dishwasher rack prong or tine, and in some embodiments, concavity 108 may include one or more side notches or slots 110 that may be adapted to accommodate a bent or horizontal portion of a dishwasher rack prong or tine. In various embodiments, concavity 108 may have an inner diameter that is sufficiently large to easily accommodate an outer diameter of a standard dishwasher rack prong or tine, but also sufficiently small to secure the bag support device 100 to the prong or tine under normal dishwasher operating forces and pressures.

In some embodiments, the length of concavity 108 may be about 3-7 inches, about 4-6 inches, or about 5 inches long. In one specific, non-limiting example, the length of concavity 108 may be about 4.8 inches. In various embodiments, the inner diameter of concavity 108 may be about 0.1-0.3 inches, or about 0.15-0.25 inches, or about 0.2 inches. In various embodiments, slot 110 may have a length of about 1-3 inches, or about 1.5-2.5 inches, or about 2 inches. In one specific, non-limiting example, slot 110 may have a length of about 1.8 inches. In particular embodiments, center shaft 102 may include a notch 114 at proximal end 104, for example to ease positioning of bag support device 100 over a dishwasher prong and/or to engage a lateral support member (e.g., a component of the dishwasher rack) at the base of the prong. In particular embodiments, notch 114 may be adapted to substantially prevent rotation of bag support device 100 around the longitudinal axis of the prong.

Although the illustrated examples are sized to fit a standard bottom rack of a dishwasher, the bag support device maybe adapted to fit the size constraints of nearly any dishwasher rack, including upper racks and racks of non-standard dishwashers. For example, while the illustrated examples have an overall length of about 9-12 inches, for example, about 10-11 inches, or about 10.5 inches in particular embodiments, a bag support device for an upper rack may have an overall length of about 6-9 inches, or about 7-8 inches, or about 7.5 inches. In various embodiments, the overall length of the device may be varied by varying the length of center shaft portion 102.

In various embodiments, distal end 104 may be configured to terminate in a flattened portion or paddle 112. In various embodiments, paddle 112 may be sufficiently sized to help retain the bag in and open position, without allowing the bag sides to contact one another, and without allowing any portion of the bag to sag and form a collection point for water. Without being bound by theory, it is believed that the dimensions of paddle 112 contribute to the efficacy of the support device 100 by being sufficiently large to (1) retain the bag on the device under normal washing pressures, and (2) maintain the bag in a substantially open position, while also (3) allowing easy positioning and removal of the bag from the bag support device 100 without removing the bag support device 100 from the dishwasher. In some examples, paddle 112 may have a width of from about 0.75-3 inches, and a height of from about 1.5-4 inches, or a width of about 1.5-2.5 inches, and a height of about 2-3 inches. In specific, non-limiting examples, paddle 112 may have a width of about 1.8-2 inches, and a height of about 2.25-2.75 inches, or a width of about 1.89 inches and a height of about 2.5 inches.

FIGS. 2A and 2B illustrate a side view (FIG. 2A) and a front view (FIG. 2B) of an example of a bag support device, in accordance with various embodiments. As illustrated in FIG. 2A, various embodiments of the bag support device 200 may have a relatively thin side profile. This allows the device to be lighter and slimmer for shipping and storage, but still strong enough to provide firm support to the bag. Thus, bag support device 200 may have sufficient rigidity to substantially prevent the device from flexing under washing pressures and load conditions. In some embodiments, excessive lateral flexion may allow the bag to become dislodged, may allow the device to separate from the dishwasher prong, and/or may allow sufficient slack in the bag that water may pool therein and impede washing and drying efficiency. As illustrated, in some embodiments, slot 210 (and notch 214) may lie in-plane with paddle 212.

As illustrated in FIG. 2B, center shaft portion 202 may include one or more flattened surfaces 202a, on which a logo, business name, recycle symbol, or other indicia may be displayed. In some embodiments, flattened surface 202a may generally align with a flat side of paddle 212, for example so that any writing or images on flattened surface 202a may automatically be displayed when support device 200 is placed in a drawer, coupled to packaging, or otherwise displayed on a flat surface.

FIG. 3 illustrates a bottom view of an example of a bag support device, in accordance with various embodiments. The illustrated example shows the spatial relationships between the center shaft 302, the concavity 308, the slot 310, the notch 314 and the paddle 312 of bag support device 300. As illustrated, in some embodiments, center shaft 302 may include a slightly flared base to increase stability, and paddle 312 may include tapered or rounded edges to prevent tearing of the bag.

In various embodiments, the bag support device may be used in pairs. For example, a first bag support device may be placed over a prong or tine in a standard dishwasher rack, such as an upper or lower rack, with the prong or tine resting within the concavity of the center shaft. In some embodiments, the prong or tine may have an angled or bent base, and/or may be coupled to another rack element (such as a base member) that may be oriented at approximately right angles to the prong or tine. In such a situation, the bag support device may be rotated as necessary to position the slot(s) over the angled portion or rack element, and downward pressure may be used to seat the device firmly on the prong or tine. A second bag support device may then be positioned in a similar manner over a second prong or tine, with the distance between the first and second prongs or tines selected to fit the bag that is to be washed. The bag may then be placed upside down and/or inside out over the first and second paddles of the first and second bag support devices, and extended fully over the devices such that it is in an open and extended position. The dishwasher may be operated in the usual fashion.

Following washing, the bag may be lifted from the first and second bag support devices and reused as desired. The bag support devices may be left in the dishwasher rack for the next use, or they may be repositioned to wash a different bag or be removed from the dishwasher for storage.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A device for supporting a plastic bag in a dishwasher, comprising:
a first bag support member, and
a second bag support member, this first and second bag support members each comprising a center shaft having a first end adapted to engage a prong of a dishwasher rack, and a second end adapted to retain a plastic bag in a desired position.

2. The device of claim 1, wherein the first end of the first and second bag support members comprises a concavity configured to allow the center shaft to fit over and at least partially encompass the prong.

3. The device of claim 2, wherein the concavity is configured to allow the center shaft to substantially completely encompass the prong.

4. The device of claim 2, wherein the first end of the first and second bag support members further comprises a lateral slot, wherein the lateral slot is adapted to accommodate a bend in the prong.

5. The device of claim 2, wherein the first end of the first and second bag support members further comprises a notch, wherein the notch is adapted to engage a lateral support member of the dishwasher rack.

6. The device of claim 5, wherein the notch is further adapted to prevent rotation of the bag support member on the prong.

7. The device of claim 2, wherein the concavity is from about 4 inches to about 6 inches in length.

8. The device of claim 7, wherein the concavity is about 5 inches in length.

9. The device of claim 2, wherein the concavity has a diameter of about 0.1-0.2 inches.

10. The device of claim 1, wherein the second end of the first and second bag support members comprises a paddle.

11. The device of claim 10, wherein the paddle has a height of from about 2 inches to about 3 inches.

12. The device of claim 11, wherein the paddle has a height of about 2.5 inches.

13. The device of claim 10, wherein the paddle has a width of from about 1.5 inches to about 2.5 inches.

14. The device of claim 13, wherein the paddle has a width of about 2 inches.

15. The device of claim 1, wherein the devices comprises plastic, rubber, aluminum, or stainless steel.

16. A device for supporting a plastic bag in a dishwasher, comprising:
a first bag support member, and
a second bag support member, this first and second bag support members each comprising a center shaft having a first end adapted to engage a prong of a dishwasher rack, and a second end adapted to retain a plastic bag in a desired position, wherein the second end of the first and second bag support members comprises a paddle, and wherein the first end of the first and second bag support members comprises:
a concavity configured to allow the center shaft to fit over and at least partially encompass the prong;
a lateral slot, wherein the lateral slot is adapted to accommodate a bend in the prong; and
a notch, wherein the notch is adapted to engage a lateral support member of the dishwasher rack.

17. A method of washing a plastic bag in a dishwasher, comprising:
selecting a first prong in a dishwasher rack;
positioning a first bag support member on the first prong, wherein the first bag support member comprises a first center shaft having a first end portion adapted to engage the first prong, and a second end portion adapted to retain the plastic bag in a desired position;
selecting a second prong in a dishwasher rack;
positioning a second bag support member on the second prong, wherein the second bag support member comprises a second center shaft having a third end portion adapted to engage the second prong, and a fourth end portion adapted to retain the plastic bag in the desired position;
positioning an open end of the plastic bag over both the second end portion of the first bag support member and the fourth end portion of the second bag support member; and
operating the dishwasher.

18. The method of claim 17, wherein the method further comprises removing the plastic bag from the first and second bag support members.

19. The method of claim 18, wherein the method further comprises moving one or both of the first and second bag support members to one or more different prongs to accommodate a second plastic bag having a different size than the first plastic bag.

20. The method of claim 17, wherein selecting the second prong in the dishwasher rack comprises selecting a second prong having a distance from the first prong that is less than or equal to a width of an opening in the plastic bag.
